(19) United States
(12) Patent Application Publication
(10) Pub. No.: US 2022/0398412 A1
(43) Pub. Date: Dec. 15, 2022

(54) OBJECT CLASSIFICATION USING AUGMENTED TRAINING DATA

(71) Applicant: GM Cruise Holdings LLC, San Francisco, CA (US)

(72) Inventor: Hariprasad Govardhanam, San Francisco, CA (US)

(21) Appl. No.: 17/346,816

(22) Filed: Jun. 14, 2021

(51) Int. Cl. G06K 9/62; G06T 11/00; G06K 9/00

(52) U.S. Cl. CPC G06K 9/6256; G06K 9/6267; G06K 9/6262; G06T 11/00; G06K 9/00791; G06N 20/00

(57) ABSTRACT

The disclosed technology provides solutions for improving object classification using machine-learning techniques. In particular, solutions for improving detection/classification in rare-event scenarios are provided. In some approaches, a process of the invention can include steps for: receiving road data, wherein the road data comprises sensor data associated with a driving scene, receiving object data from an object database, and inserting a virtual object, at a first location, within the driving scene, wherein the virtual object is based on the object data. In some aspects, the process can further include steps for performing an object identification process to classify the virtual object at the first location in the driving scene. Systems and machine-readable media are also provided.

### BACKGROUND

### 1. Technical Field

The disclosed technology provides solutions for improving object classification and in particular, improving detection/classification in rare-event scenarios using machine-learning techniques.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 conceptually illustrates a system for performing training-data augmentation, according to some aspects of the disclosed technology.

FIGS. 2A and 2B illustrate example driving scenarios resulting from a training-data augmentation process, according to some aspects of the disclosed technology.

FIG. 3 illustrates a block diagram of a process for performing object classification using augment training data, according to some aspects of the disclosed technology.

FIG. 4 illustrates an example system environment that can be used to facilitate AV dispatch and operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Fast and accurate object detection and classification are necessary to the performance of autonomous vehicle (AV) perception functions. In some implementations, detection models (e.g., machine-learning models) are used to perform object identification/classification. For example, by classifying encountered objects with semantic labels, the AV can better reason about how to navigate safely and efficiently through various situational contexts.

For machine-learning (ML) based perception implementations, classification accuracy for any given object type is dependent on the amount of available training data for that object. Where an abundant amount of training data includes a high frequency of a particular object class, such as bicycles, the classification accuracy for that particular class (e.g., bicycles) can be high. For example, when provided with adequate amounts of training data, the ML model can train and adapt to object encounters that occur under different conditions, such as different distance, orientation, and/or occlusion conditions.

However, for rarely encountered objects or object-contexts, a relative poverty of training data can negatively affect classification accuracy. For example, object classification performed on rarely encountered objects, such as a giraffe on the side of the road, or in rare contexts, such as a bicycle hanging from a traffic-light, may not achieve a level of accuracy that is adequate for AV perception demands.

Aspects of the disclosed technology address the foregoing limitations of ML-based AV perception training by providing solutions for augmenting training data to improve classification accuracy for rare event and/or rare contexts. In some approaches, training data can be augmented to increase a frequency of object occurrence, and/or to increase the diversity of object context, such as by increasing the variance object posture, or distance. Additionally, as discussed in further detail below, the variance of environmental context can also be increased, for example, by diversifying sensing conditions, such as lighting, depth-perception, and/or occlusion parameters.

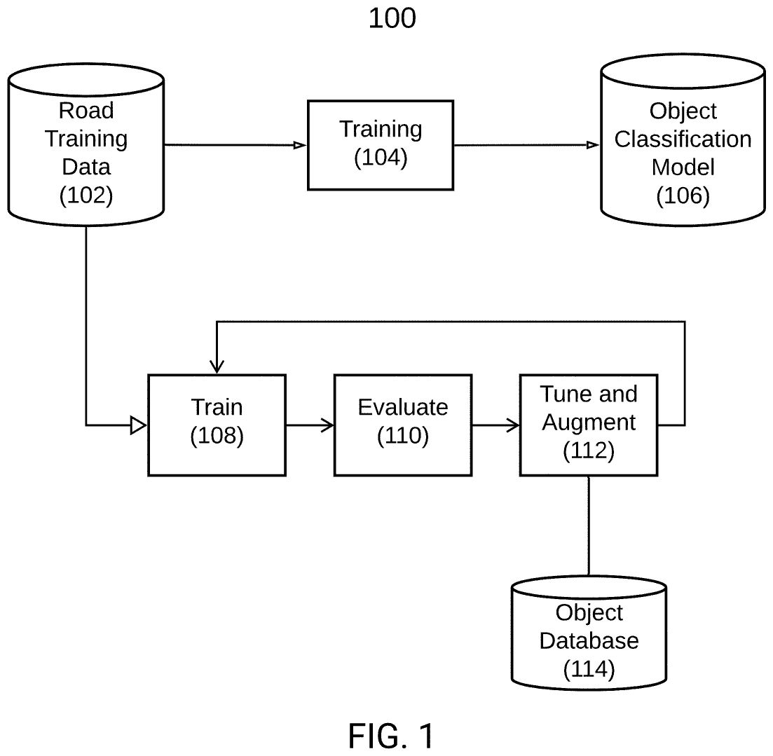

FIG. 1 conceptually illustrates a system 100 for performing training-data augmentation. In some aspects, training data can be collected into a database or other data repository, e.g., road training data 102. The training data can include data collected from physical sensors, such as vehicle sensors, during the course of AV operation (e.g., as road data, bag data, or road bag data). In other aspects, training data can include synthetic data collected or originated from a generated three-dimensional (3D) environment, e.g., a simulated environment. In such instances, sensor data can also include synthetic data, for example, corresponding with data collected from a synthetic 3D environment using simulated (synthetic) sensors.

Irrespective of how training data is collected, a variety of sensor modalities can be represented in the training data, including but not limited to: LiDAR data, camera data, radar data, time-of-flight sensor data, and the like. In some aspects, the training data can include (or can represent) recorded data for a driving scene, such as data representing movement of a vehicle through a physical space. By way of example, the training data can correspond with data collected by various AV sensors (either real or simulated), for example, as the AV moves drives on various roadways and experiences different encounters in the course of operation. As such, the training data can include various objects, such as other active traffic participants, including but not limited to: vehicles or motorists, bicyclists, and/or pedestrians, etc. In some aspects, the training data can include other objects that are detected by vehicle sensors (either real or simulated), including but not limited to: atmospheric events (e.g., steam or mist emanating from man-hole covers), buildings, trees, bushes, light-poles, etc. It is understood that training data can include virtually any object that can be detected by AV sensors, without departing from the scope of the disclosed technology.

Training data 102 can be used to perform training with respect to one or more machine-learning (ML) models. In the context of AV perception operations, training can include the refinement of object classification models used to identify (classify) objects encountered during the course of typical AV operations. ML models trained using training data 102 can have significant performance improvements for classifying rare objects and objects in rare contexts.

In some aspects, training data can be enriched to augment training for certain object types, and to thereby to improve the classification accuracy of those objects and encounter contexts. As illustrated in the example of FIG. 1, training data augmentation can be performed based on classification performance for one or more object types, or driving scenarios. Training data (block 108) can be evaluated (block 110) to determine object classification accuracies for a variety of objects, across a variety of object-placement scenarios. In some aspects, classification performance can be evaluated with respect to specific object characteristics, including but not limited to: object type, pose, or placement, etc. Additionally, various classification performance metrics may be used to determine classification accuracy, including but not limited to: object classification accuracy percentages, Intersect Over Union (IoU) metrics, and/or heading error metrics, or the like.

In some approaches, classification performance metrics that fall below a pre-determined threshold can trigger a training data tuning/augmentation process (block 112). For example, if an object of a specific type (e.g., an electric scooter), is accurately classified less than X% of the time, where X is the pre-determined threshold, then augmentation may be performed for that object type. By way of further example, the training data may be augmented to include a greater number of scooters and/or a greater amount of object placement variety, such as by increasing the number of different object (scooter) orientations/poses represented in the training data. By increasing the frequency of electric scooter instances in the training data, a corresponding increase in simulated AV-electric scooter encounters can be used to train detection classifiers, thereby improving classification accuracy for those objects and/or scenarios. Training data augmentation of this type is particularly useful for improving perception for rarely encountered scenarios or for rarely occurring objects.

The process of augmenting training data to perform object insertion can require the modification of the sensor data in a manner that comports with the physical constraints of the corresponding sensor modality. For example, accurate object insertions may be performed by considering changes to a field-of-view available to the sensor at different distances or fields of depth. By way of example, the insertion of an object closer to the data collection point (e.g., a LiDAR/camera sensor) can result in a greater number of data points (larger field-of view), whereas the insertion of the same object, or an object of a similar size at a greater distance from the sensor may include fewer data points. For both LiDAR and camera sensors, pixel intensity variations can also depend on various factors, including but not limited to: atmospheric conditions, daylight conditions, object reflectivity properties, object distance properties, object occlusions, etc. Further details regarding the modification of training (sensor) data to simulate object insertions are discussed in further detail, below.

Although the foregoing describes a process of performing object classification training and model generation in the context of AV perception operations, it is understood that the training process can be generalized to other contexts, without departing from the scope of the disclosed technology.

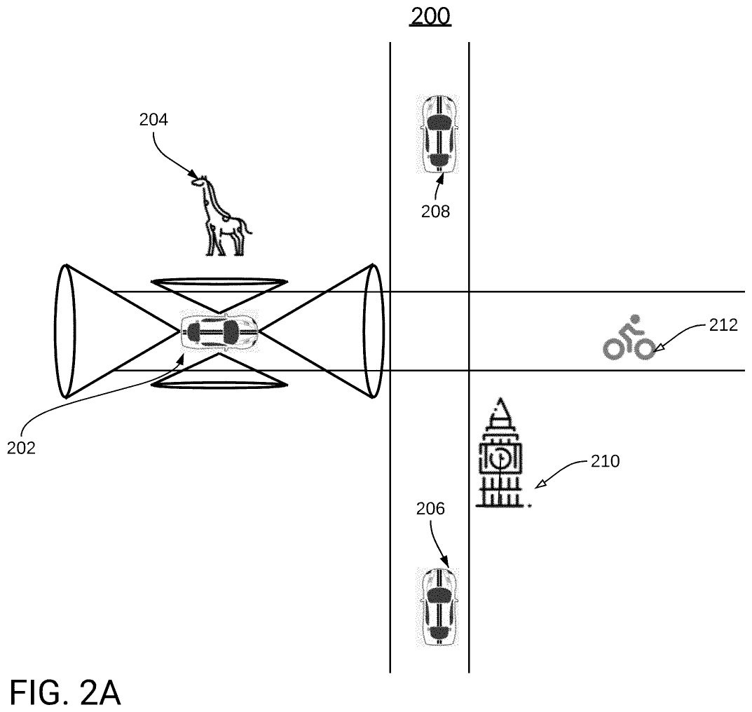

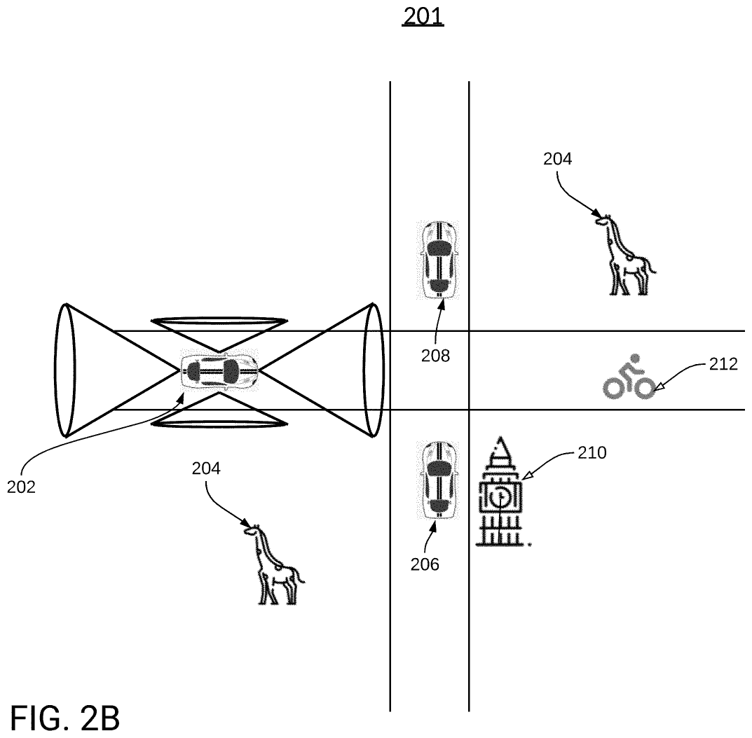

FIG. 2A illustrates an example driving scenario 200 resulting from a training-data augmentation process, according to some aspects of the disclosed technology. In the example of FIG. 2A, scenario 200 can represent a three-dimensional scene corresponding with road data collected by various AV sensors (e.g., LiDAR sensors, radar, sensors and/or cameras, etc.) of AV 102. By way of example, the roadways, and traffic participants, such as, vehicles 106, 108, and bicyclist 112 can be entities represented in an originally recorded version of road data collected by AV 102. Additionally, some objects, such as building 110, can be represented by the recorded data. However, in the example of scenario 200, object 104 can represent an inserted object, for example, that has been inserted into the scene for the purpose of augmenting the corresponding training data. As discussed above, by placing infrequently encountered objects, or object encounter contexts, into the training data, machine-learning classifier accuracy for those objects/encounter scenarios can be improved.

In the example of FIG. 2A, AV object detection of the inserted object 204 can be improved as exposure frequency increases, and as object 204 is placed at different locations within the scenario 200. By way of further example, FIG. 2B illustrates another driving scenario 201 that includes some of the traffic participants from scenario 200 (e.g., vehicles 206, 208, and bicyclist 212), as well as some of the same objects (e.g., building 210). However, in the example of FIG. 2B, object 204 is provided at multiple different locations, and at different distances from AV 202.

The modification of the road data necessary to insert object 204 into the scene (e.g., either scene 200 or 201), is performed in a manner that takes consideration of the object distance from the AV 202, the object orientation (pose), any occlusions caused by other objects in the scene. In the example of FIG. 2A, object 204 is relatively close to AV 202, and not occluded by any other objects in the scene. However, in the example of FIG. 2B, on instance of object 204 is at least partially occluded by vehicle 208; additionally, building 210 is at least partially occluded by vehicle 206. Changes to the insertion frequency, distance, orientation, and occlusion properties can be used to enhance the training data, and thereby to increase the classification accuracy for a given object type.

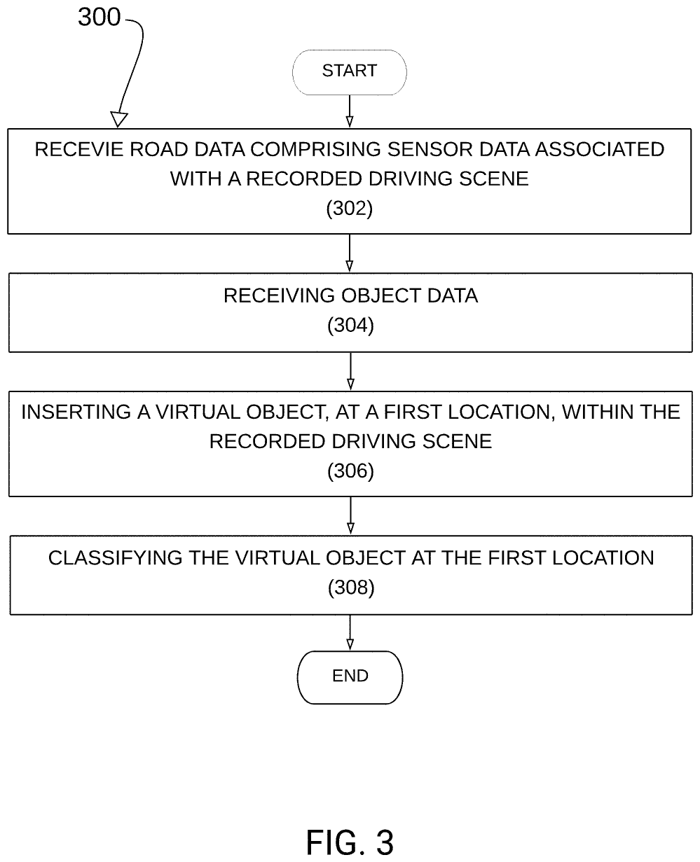

FIG. 3 illustrates a block diagram of a process 300 for performing object classification. Process 300 begins with step 302 in which road data is received, e.g., by a training data augmentation system/process of the disclosed technology. The road data can include sensor data for a recorded driving scene. As discussed above with respect to FIGS. 2A and 2B, the road data can represent a driving scenario of a vehicle (AV), on a particular course through a 3D environment, such as those represented by scenarios 200, and 201. As such, the road data can include various objects, including other traffic participants or entities, and non-traffic participants and static objects, such as buildings, trees, and other map features.

Depending on the desired implementation, collection of road data can occur using physical sensors, for example, by recording sensor data from the perspective of a vehicle, such as an AV. Alternatively, the road data may be generated using a simulated environment, such as by simulating sensor perception of movement through a virtual 3D environment. As such, the road data can include sensor data created using physical sensors (e.g., one or more LiDARs, radars, and/or cameras, etc), or that is generated using simulated (synthetic) sensors, e.g., using one or more synthetic LiDARs, radars, time-of-flight sensors, and/or cameras, etc.

In step 304, process 300 includes receiving an object from an object database. In some aspects, the object is selected for insertion in response to a performance metric for prior classifications of that object type. For example, the object selected at step 304 may correspond with an object class for which classification accuracy (e.g., by one or more machine-learning models) is relatively low. By way of example, the selected object may include an object that is infrequently encountered, or for which a greater variety of contextual encounters is desired to be simulated.

In some aspects, the selected object can be based on object data that was collected by one or more physical sensors. For example, the object may be one that was encountered by an AV during the course of operation, and that was detected by one or more AV sensors, such as mounted LiDAR and/or camera sensors. In other aspects, the selected object may be entirely synthetic, e.g., comprising object data that was generated using a synthetic process, such as by simulating the object using a 3D simulation platform.

In step 306, process 300 includes inserting a virtual object into a first location within the driving scene. In some aspects, the virtual object can be based on the object data. For example, the virtual object may correspond with a modified version of an object corresponding with the object data, such as a rotated, or re-sized version of an originally recorded object.

As discussed above, insertion of the virtual object into the driving scene can include modification of data for the driving scene, such as various portions of sensor data in the received road data. Additionally, the insertion process can take consideration of several factors including a determination of one or more locations within the recorded driving scene where the virtual object is to be inserted. For example, as discussed above with respect to FIG. 2A a virtual object (e.g., object 104) is inserted at a single location within the recorded driving scene 200, whereas in the example of FIG. 2B, the virtual object is inserted at multiple locations. Other insertion considerations can include, but are not limited to: determinations of object distance, and/or occlusion characteristics, etc.

At step 308, process 400 includes classifying the virtual object, e.g., at the first location using the modified scene data. By performing classification on the inserted (virtual) object, the accuracy of various object detection/classification models can be improved, with respect to that object type and insertion context. As such, the modified road data can be used as training data to improve object classification for any type of virtual object that is inserted into the recorded driving scene.

Similar, to the examples discussed above with respect to FIGS. 2A and 2B, additional or subsequent object insertions can also be performed to augment the training data. For example, one or more instances of the virtual object may be inserted into the recorded driving scene, e.g., a various other locations within the scene, such as at a second and/or third location withing the driving scene. By varying the frequency of insertion and insertion conditions (context), object classification can be improved for specific object types and scenarios.

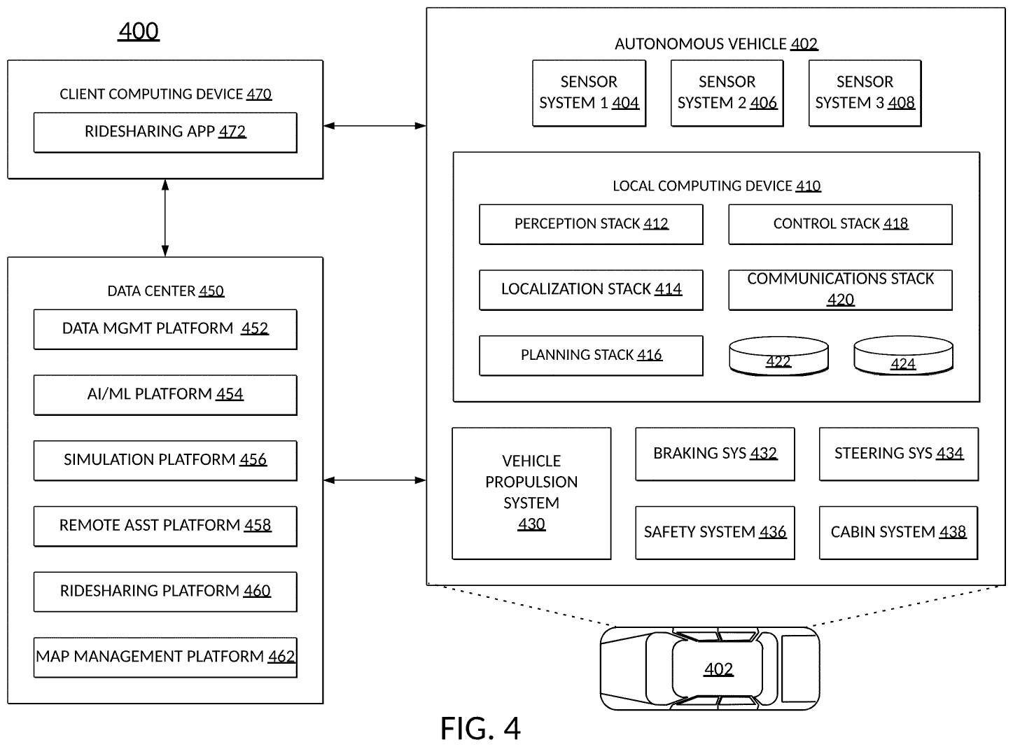

Turning now to FIG. 4 illustrates an example of an AV management system 500. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 402 can navigate about roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

AV 402 can also include several mechanical systems that can be used to maneuver or operate AV 402. For instance, the mechanical systems can include vehicle propulsion system 430, braking system 432, steering system 434, safety system 436, and cabin system 438, among other systems. Vehicle propulsion system 430 can include an electric motor, an internal combustion engine, or both. The braking system 432 can include an engine brake, brake pads, actuators, and/or any other suitable componentry configured to assist in decelerating AV 402. The steering system 434 can include suitable componentry configured to control the direction of movement of the AV 402 during navigation. Safety system 436 can include lights and signal indicators, a parking brake, airbags, and so forth. The cabin system 438 can include cabin temperature control systems, in-cabin entertainment systems, and so forth. In some embodiments, the AV 402 may not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a planning stack 416, a control stack 418, a communications stack 420, an HD geospatial database 422, and an AV operational database 424, among other stacks and systems.

Perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 422, other components of the AV, and other data sources (e.g., the data center 450, the client computing device 470, third-party data sources, etc.). The perception stack 412 can detect and classify objects and determine their current and predicted locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth.

Mapping and localization stack 414 can determine the AV's position and orientation (pose) using different methods from multiple systems (e.g., GPS, IMUs, cameras, LIDAR, RADAR, ultrasonic sensors, the HD geospatial database 422, etc.). For example, in some embodiments, the AV 402 can compare sensor data captured in real-time by the sensor systems 404-408 to data in the HD geospatial database 422 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The planning stack 416 can determine how to maneuver or operate the AV 402 safely and efficiently in its environment. For example, the planning stack 416 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another. The planning stack 416 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 416 can select from multiple backup plans to carry out. For example, while preparing to change lanes to turn right at an intersection, another vehicle may aggressively cut into the destination lane, making the lane change unsafe. The planning stack 416 could have already determined an alternative plan for such an event, and upon its occurrence, help to direct the AV 402 to go around the block instead of blocking a current lane while waiting for an opening to change lanes.

The control stack 418 can manage the operation of the vehicle propulsion system 430, the braking system 432, the steering system 434, the safety system 436, and the cabin system 438. The control stack 418 can receive sensor signals from the sensor systems 404-408 as well as communicate with other stacks or components of the local computing device 410 or a remote system (e.g., the data center 450) to effectuate operation of the AV 402. For example, the control stack 418 can implement the final path or actions from the multiple paths or actions provided by the planning stack 416. This can involve turning the routes and decisions from the planning stack 416 into commands for the actuators that control the AV's steering, throttle, brake, and drive unit.

The communication stack 420 can transmit and receive signals between the various stacks and other components of the AV 402 and between the AV 402, the data center 450, the client computing device 470, and other remote systems. The communication stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 420 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 422 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408 and other components of the AV 402 and/or data received by the AV 402 from remote systems (e.g., the data center 450, the client computing device 470, etc.). In some embodiments, the raw AV data can include HD LIDAR point cloud data, image data, RADAR data, GPS data, and other sensor data that the data center 450 can use for creating or updating AV geospatial data as discussed further below with respect to FIG. 2 and elsewhere in the present disclosure.

The data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, a ridesharing platform 460, and map management system platform 462, among other systems.

Data management platform 452 can be a “big data” system capable of receiving and transmitting data at high velocities (e.g., near real-time or real-time), processing a large variety of data, and storing large volumes of data (e.g., terabytes, petabytes, or more of data). The varieties of data can include data having different structure (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from ifferent sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the map management system platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the map management system platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from the map management system platform 462; modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smart watch, smart eyeglasses or other Head-Mounted Display (HMD), smart ear pods or other smart in-ear, on-ear, or over-ear device, etc.), gaming system, or other general purpose computing device for accessing the ridesharing application 472. The client computing device 470 can be a customer's mobile computing device or a computing device integrated with the AV 402 (e.g., the local computing device 410). The ridesharing platform 460 can receive requests to be picked up or dropped off from the ridesharing application 472 and dispatch the AV 402 for the trip.

Map management system platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, UAVs, satellites, third-party mapping services, and other sources of geospatially referenced data. The raw data can be processed, and map management system platform 462 can render base representations (e.g., tiles (2D), bounding volumes (3D), etc.) of the AV geospatial data to enable users to view, query, label, edit, and otherwise interact with the data. Map management system platform 462 can manage workflows and tasks for operating on the AV geospatial data. Map management system platform 462 can control access to the AV geospatial data, including granting or limiting access to the AV geospatial data based on user-based, role-based, group-based, task-based, and other attribute-based access control mechanisms. Map management system platform 462 can provide version control for the AV geospatial data, such as to track specific changes that (human or machine) map editors have made to the data and to revert changes when necessary. Map management system platform 462 can administer release management of the AV geospatial data, including distributing suitable iterations of the data to different users, computing devices, AVs, and other consumers of HD maps. Map management system platform 462 can provide analytics regarding the AV geospatial data and related data, such as to generate insights relating to the throughput and quality of mapping tasks.

In some embodiments, the map viewing services of map management system platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridesharing platform 460 may incorporate the map viewing services into the client application 472 to enable passengers to view the AV 402 in transit en route to a pick-up or drop-off location, and so on.

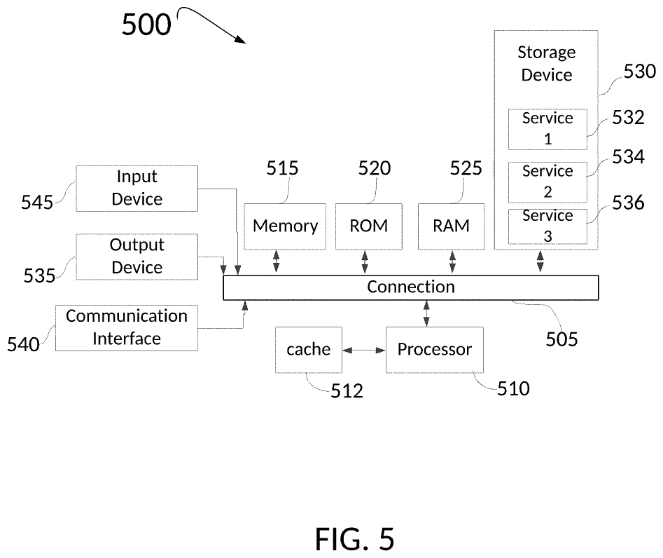

FIG. 5 illustrates an example processor-based system with which some aspects of the subject technology can be implemented. For example, processor-based system 500 can be any computing device making up internal computing system 510, remote computing system 550, a passenger device executing the rideshare app 570, internal computing device 530, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A system comprising:
one or more processors; and
a computer-readable medium coupled to the one or more processors, wherein the computer-readable medium comprises instructions that are configured to cause the one or more processors to perform operations comprising:
receiving road data, wherein the road data comprises sensor data associated with a driving scene;
receiving object data from an object database;
inserting a virtual object, at a first location, within the driving scene, wherein the virtual object is based on the object data; and
performing an object identification process to classify the virtual object at the first location in the driving scene.

2. The system of claim 1, wherein inserting the virtual object further comprises:
determining an orientation of the virtual object for insertion at the first location.

3. The system of claim 1, wherein the one or more processors are further configured to perform operations comprising:
inserting the virtual object into a second location within the driving scene; and
performing an object identification process to classify the virtual object at the second location in the driving scene.

4. The system of claim 1, wherein the one or more processors are further configured to perform operations comprising:
inserting the virtual object into one or more subsequent locations within the driving scene, based on a performance metric associated with prior classification of the virtual object.

5. The system of claim 1, wherein the sensor data associated with the driving scene comprises one or more of: Light Detection and Ranging (LiDAR) data, or camera image data.

6. The system of claim 1, wherein the object data comprises recorded sensor data.

7. The system of claim 1, wherein the object data represents a synthetic object.

8. A computer-implemented method, comprising:
receiving road data, wherein the road data comprises sensor data associated with a driving scene;
receiving object data from an object database;
inserting a virtual object, at a first location, within the driving scene, wherein the virtual object is based on the object data; and
performing an object identification process to classify the virtual object at the first location in the driving scene.

9. The computer-implemented method of claim 8, wherein inserting the virtual object further comprises:
determining an orientation of the virtual object for insertion at the first location.

10. The computer-implemented method of claim 8, further comprising:
inserting the virtual object into a second location within the driving scene; and
performing an object identification process to classify the virtual object at the second location in the driving scene.

11. The computer-implemented method of claim 8, further comprising:
inserting the virtual object into one or more subsequent locations within the driving scene, based on a performance metric associated with prior classification of the virtual object.

12. The computer-implemented method of claim 8, wherein the sensor data associated with the driving scene comprises one or more of: Light Detection and Ranging (LiDAR) data, or camera image data.

13. The computer-implemented method of claim 8, wherein the object data comprises recorded sensor data.

14. The computer-implemented method of claim 8, wherein the object data represents a synthetic object.

15. A non-transitory computer-readable storage medium comprising instructions stored therein, which when executed by one or more processors, cause the processors to perform operations comprising:
receiving road data, wherein the road data comprises sensor data associated with a driving scene;
receiving object data from an object database;
inserting a virtual object, at a first location, within the driving scene, wherein the virtual object is based on the object data; and
performing an object identification process to classify the virtual object at the first location in the driving scene.

16. The non-transitory computer-readable storage medium of claim 15, wherein inserting the virtual object further comprises:
determining an orientation of the virtual object for insertion at the first location.

17. The non-transitory computer-readable storage medium of claim 15, wherein the instructions further configured to cause the processors to perform operations comprising:
inserting the virtual object into a second location within the driving scene; and
performing an object identification process to classify the virtual object at the second location.

18. The non-transitory computer-readable storage medium of claim 15, wherein the instructions further configured to cause the processors to perform operations comprising:
inserting the virtual object into one or more subsequent locations within the driving scene, based on a performance metric associated with prior classification of the virtual object.

19. The non-transitory computer-readable storage medium of claim 15, wherein the sensor data associated with the driving scene comprises one or more of: Light Detection and Ranging (LiDAR) data, or camera image data.

20. The non-transitory computer-readable storage medium of claim 15, wherein the object data comprises recorded sensor data.
